(19) United States
(12) Patent Application Publication
(10) Pub. No.: US 2006/0237375 A1
(43) Pub. Date: Oct. 26, 2006

(54) Bonded fiber structures for use in blood separation

(76) Inventors: Jian Xiang, Midlothian, VA (US); Bennett C. Ward, Midlothian, VA (US); Andreas Schneekloth, Hamburg (DE); Jackie F. Payne JR., Chester, VA (US)

Correspondence Address: HUNTON & WILLIAMS LLP;Riverfront Plaza, East Tower, 951 E. Byrd Street, Richmond, VA, 23219-4074, US

(21) Appl. No.: 11/385,336

(22) Filed: Mar. 21, 2006

Related U.S. Application Data
(60) Provisional application No. 60/664,032, filed on Mar. 22, 2005.

(51) Int. Cl. B01D 21/26

(52) U.S. Cl. 210/787; 210/767; 210/512.1; 210/503; 210/505

(57) ABSTRACT

A barrier element for use in separating blood components is provided. The barrier element comprises a self-sustaining, fluid transmissive body comprising a plurality of thermoplastic fibers bonded to each other at spaced apart points of contact, the fibers collectively defining a tortuous fluid flow path through the fluid transmissive body from a fluid inlet surface to a fluid outlet surface, the fibers and the fluid transmissive body being configured to allow passage of at least one blood component therethrough while preventing the passage of a second blood component.

This application claims priority to U.S. Provisional Patent Application Ser. No. 60/664,032, filed on Mar. 22, 2005, titled “Elastomeric Bicomponent Fibers and Bonded Fiber Structures Formed Therefrom,” which is incorporated herein by reference in its entirety. The application is also related to U.S. application Ser. No. ______, filed Mar. 14, 2006 under Attorney Docket No. 61633.001139, which is also incorporated herein by reference in its entirety.

### BACKGROUND OF THE INVENTION

The present invention is generally directed to barriers for use in blood separation applications. More particularly, the present invention is directed to barriers for use in blood separation applications formed from bonded fiber structures.

Blood is composed of several components, including “solid” blood components such as red blood cells, white blood cells, and platelets, and plasma or serum. Plasma is the term used to indicate the liquid component of blood in which the solid blood components are suspended. Plasma generally indicates the liquid component in its entirety, while serum indicates the liquid component when clotting factors (such as fibrin) have been removed. For ease of discussion, “plasma” will be used to denote either plasma or serum.

The separation of blood into solid components and plasma is quite important. Plasma is useful for various laboratory tests, and may be used to make products to treat and prevent diseases such as tetanus, rabies, measles, rubella and hepatitis B. Plasma may also be used in the treatment of disorders such as hemophilia and immune system deficiencies. Albumin, a protein derived from plasma is also used in the treatment of traumatic injuries such as shock and severe burns. Plasma is also an important source of analytes for a variety of diagnostic tests, including tests for cholesterol, lipids, blood glucose and glycogen, a wide variety of proteins, and many other analytes of interest.

Plasma cannot be produced through artificial means. Accordingly, there is a need to effectively and efficiently separate blood into its respective components in order to isolate the plasma.

Blood can be separated into its constituent components through centrifugation. Centrifugation causes the various solid components of blood to separate. A centrifuge generally spins a sample of blood in a centrifuge tube, using centrifugal action to cause the heavier (more dense/higher specific gravity) solid blood components to migrate to one end of the centrifuge tube while the lighter (less dense/lower specific gravity) plasma moves to the other end. The result is a solid blood component-rich phase at one end of the tube and a plasma-rich phase at the other end.

However, upon cessation of the acceleration force of the centrifuge, the components tend to remix. Therefore, there is a need for a barrier of some kind to maintain the division of plasma from the solid components of the blood. The difficulty in providing such a barrier is that it must be established while maintaining the integrity of the sample. This generally means that the sample container cannot be opened to allow the introduction of other materials after the blood components have been separated. Another difficulty stems from the potential for damage to red blood cells (hemolysis) during and after separation.

One method that has been used to overcome this difficulty is to introduce into the sample container a barrier gel that has a specific gravity between the specific gravities of the materials to be separated; e.g., between the specific gravity of blood plasma and the specific gravity of red blood cells. When the red blood cells are separated from the plasma under centrifugation, the gel forms a layer intermediate the red blood cells and the plasma and maintains their separation. Although this system is now widely used in blood collection tubes, it has several significant problems. For example, there is a tendency for bubbles to form in the gel after sterilization. This can result in cross contamination of cells and plasma and consequent inaccuracy of diagnostic analysis.

A variant of the above approach is used in serum-separating tubes (SSTs). These tubes generally contain an inert catalyst (such as glass beads or powder) to facilitate clotting along with a gel similar to that described above. Upon centrifugation, the inert catalyst causes the platelets and other clotting components to clot, and the gel assumes a position between the solid components (now including the clotted factors) and the serum.

These prior art systems are generally limited in both their effectiveness and their methods of use. For example, as noted above, use of the gel system may be disrupted by the formation of bubbles or other defects in the gel after sterilization, which may result in cross contamination. Similar drawbacks exist for the SST. Moreover, these prior art systems rely solely on the centrifugation process to effectively divide the blood into its respective components. Should the centrifugation be incomplete, the gel will not form the necessary barrier between the blood cells and the plasma.

There is accordingly a need for a reliable, effective barrier for use in blood separation devices.

### SUMMARY OF THE INVENTION

Aspects of the invention include a barrier element for use in separating blood components. The barrier element comprises a self-sustaining, fluid transmissive body comprising a plurality of thermoplastic fibers bonded to each other at spaced apart points of contact, the fibers collectively defining a tortuous fluid flow path through the fluid transmissive body from a fluid inlet surface to a fluid outlet surface, the fibers and the fluid transmissive body being configured to allow passage of at least one blood component therethrough while preventing the passage of a second blood component.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1A is a schematic diagram illustrating the interaction between a barrier and blood components before centrifugation, in accordance with some embodiments of the invention.

FIG. 1B is a schematic diagram illustrating the interaction between a barrier and blood components at some point during centrifugation, in accordance with some embodiments of the invention.

FIG. 1C is a schematic diagram illustrating the interaction between a barrier and blood components at some point during centrifugation, in accordance with some embodiments of the invention.

FIG. 1D is a schematic diagram illustrating the interaction between a barrier and blood components after centrifugation, in accordance with some embodiments of the invention.

FIG. 2A is a schematic diagram illustrating the interaction between a barrier and blood components before centrifugation, in accordance with some embodiments of the invention.

FIG. 2B is a schematic diagram illustrating the interaction between a barrier and blood components at some point during centrifugation, in accordance with some embodiments of the invention.

FIG. 2C is a schematic diagram illustrating the interaction between a barrier and blood components at some point during centrifugation, in accordance with some embodiments of the invention.

FIG. 2D is a schematic diagram illustrating the interaction between a barrier and blood components after centrifugation, in accordance with some embodiments of the invention.

FIG. 3 is a photograph of an unpierced barrier formed from ECM fibers after 100 hours of blood separation, in accordance with some embodiments of the invention.

FIG. 4 is a photograph of a pierced barrier formed from ECM fibers, in accordance with some embodiments of the invention.

FIG. 5 is a photograph of a pierced barrier formed from ECM fibers after 100 hours of blood separation, in accordance with some embodiments of the invention.

### DETAILED DESCRIPTION OF THE INVENTION

Reference will now be made in detail to embodiments of the invention, examples of which are illustrated in the accompanying drawings.

As used herein, “blood” means blood in its unseparated state, consisting of plasma, red blood cells, white bloods cells, and platelets.

As used herein, “blood components” means both solid blood components and plasma.

As used herein, “plasma” means the liquid component of blood, in which the solid components of blood are suspended, both with and without clotting factors. “Plasma,” therefore, means what is also considered to be serum.

As used herein, “solid components” or “solid blood components” refers to red blood cells, white blood cells, and platelets.

As noted above, the primary difficulty in providing a barrier for the separation of blood components is the necessity of avoiding contamination of the plasma sample. This constraint generally requires that the barrier be present in the collection vile or other container before the blood is introduced into the container. As a consequence, the barrier or barrier material must be capable of allowing one or more blood components to flow through or around the barrier during the separation process, but prevent passage of these components once the separation process has been completed.

The present invention solves the barrier problem through the use of three dimensional, fluid transmissive, bonded fiber structures that are tailored specifically to allow passage of certain blood components under certain conditions and prevent passage of some or all of the blood components under other conditions.

Porous, bonded structures formed from polymeric fibers have long demonstrated their advantages in filtering and fluid manipulation applications. Such structures and their manufacture are described in detail in U.S. Pat. Nos. 5,607,766, 5,620,641, 5,633,082, 6,103,181, 6,330,883, and 6,840,692, each of which is incorporated herein by reference in its entirety. Briefly summarized, bonded fiber structures are typically formed from webs or tows of thermoplastic fibers bonded to each other at spaced points of contact to form self-sustaining, three-dimensional structures. These structures have a complex internal network of tortuous pathways through which fluids may be forced, drawn or wicked. They make excellent filtration devices because fluid-carried particles are unable to negotiate these pathways.

As will be discussed in more detail below, bonded fiber structures may be formed from a wide variety of fiber materials and types and can be tailored with specific structural characteristics. Of particular interest with respect to the blood separation problem is the ability to tailor the porosity and specific gravity of bonded fiber structures formed from certain fiber materials.

It has been found that two types of bonded fiber elements may be used to solve the blood separation problem. The first type involves structuring the bonded fiber element so that under particular conditions (e.g., under centrifugal action), all blood components can pass through the bonded fiber element, but under other conditions (e.g., the 1 g (standard gravity) conditions experienced upon removal of the centrifugal action), the bonded filter element prevents the passage of one or more solid blood components such as red blood cells. The second type involves structuring the element so that certain blood components can pass through the element, but other components cannot.

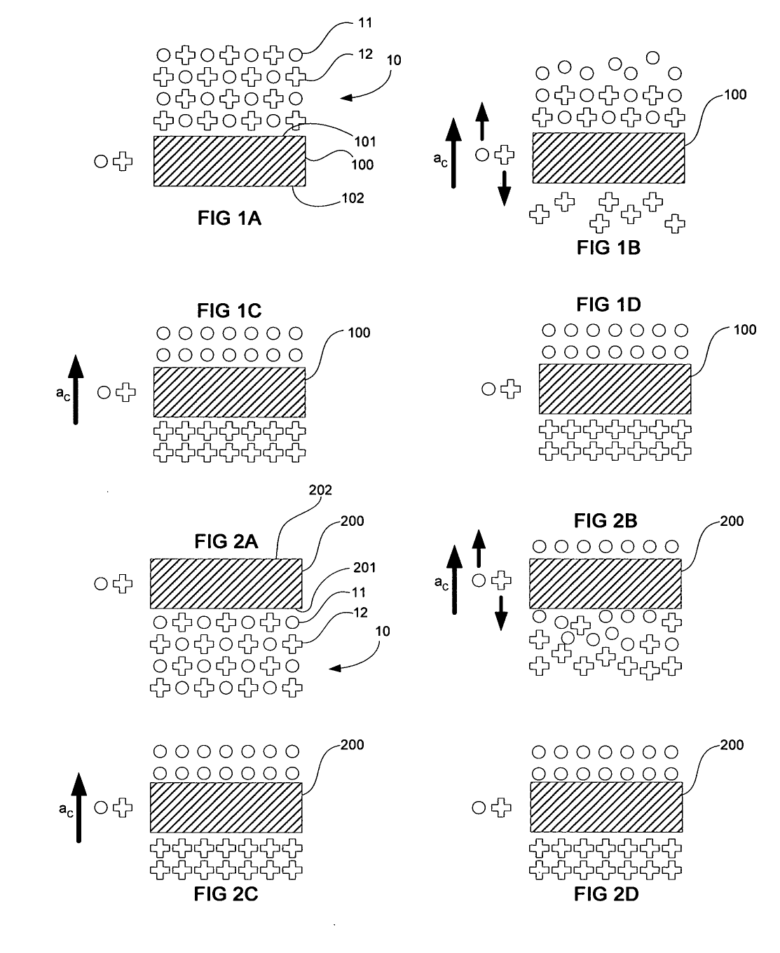

Bonded fiber barrier elements of both types will now be described in more detail. With reference to FIGS. 1A-1D, a bonded fiber barrier element 100 is formed so that the tortuous, interstitial passages will allow the passage of all blood components when a sufficient flow potential is present. When this flow potential is removed, however, the barrier element 100 prevents the passage of solid blood component materials that are too large and/or too massive to pass through the passages of the barrier element 100.

In some embodiments, solid blood components may be prevented from passing through the barrier 100, while plasma may still pass. The particular conditions that allow blood components to pass through the barrier 100 may include those conditions experienced under centrifugation. As will be understood by those of ordinary skill in the art, centrifugation of a container of blood establishes a centripetal acceleration a_{C} toward the center of rotation. This causes the blood materials to separate according to their specific gravity. The difference in specific gravity between components establishes a flow potential of one component relative to another. Upon separation, the less dense blood components tend to move in the direction of the center of rotation. The more dense blood components tend to move away from the center of rotation.

FIGS. 1A-1D illustrate the action of the bonded fiber barrier element 100. As illustrated in FIG. 1A, unseparated blood 10 comprising plasma 11 (schematically depicted as circles) and solid blood components 12 (schematically depicted as crosses) is initially disposed on one side of the barrier 100 at t₀. The barrier 100 has a first surface 101 that is in contact with the unseparated blood and an opposing second surface 102. The bonded fiber structure of the barrier element 100 is structured so that under the initial 1 g conditions, the unseparated blood 10 is inhibited from passing through the barrier 100.

With reference to FIG. 1B, at time t₁, centrifugation has begun. Under centrifugation, the plasma 11 and the solid components 12 begin to separate and a relative flow potential between the components is established based on their differences in specific gravity. This causes the solid components 12 to migrate toward one side of the container and the plasma 11 to migrate toward the other side of the container. This flow potential provides a net force on the solid components that, absent sufficient resistance, would force the solid components through the barrier element 100. The bonded fiber barrier element 100 is configured so that under this flow potential, the solid components 12 are allowed to pass into and through the internal passageways of the bonded fiber element 100.

At time t₂ centrifugation is still in process, but the blood has fully separated into plasma 11 and solid blood components 12, as illustrated in FIG. 1C. When the blood is completely separated there is no longer a relative flow potential between the components. It will be understood that the flow potential may cease due to complete separation before centrifugation is stopped. However, if the blood components are not fully separated and centrifugation is ceased, the force separating the blood components (i.e., centrifugation) and therefore the force causing the flow potential is stopped, and the solid components 12 remaining on the plasma side of the barrier 100 will not pass through the barrier 100.

When centrifugation ceases at time t_{F}, illustrated in FIG. 1D, the initial conditions are reestablished. Under these conditions, there is no flow potential or other driving force sufficient to cause the solid blood components 12 to pass through the barrier 100. The barrier 100 thus maintains separation of the plasma 11 and the solid blood components 12.

The bonded fiber barrier element 100 may be formed so that plasma would tend to pass through the barrier element 100 under lower forces than those experienced under centrifugation. In some embodiments, the plasma could pass through the barrier element 100 even under 1 g conditions. In such embodiments, the relative placement of the barrier element 100 within a blood separation container may assist in maintaining separation of the plasma from other components. Blood is a known percentage of solid components 12 and plasma 11. In general, blood is comprised of approximately 55% plasma 11 and 45% solid components 12. A given volume of blood is known to break down to a given amount of solid blood components 12 and plasma 11. Accordingly, if the volume of a container is known, and the volume of blood added to the container is known, the dividing line between the plasma 11 and the solid blood components 12 may be determined. Placement of the barrier element 100 at this location will prevent passage of plasma 11 after separation because the volume into which the plasma 11 would flow is filled with the solid blood components 12. These solid blood components 12 could not be displaced by the plasma 11, because, under the conditions imposed, the solid blood components 12 cannot pass back through the barrier element 100.

In a particular use of the barrier 100 in accordance with some embodiments of the invention, the barrier 100 and the blood may be placed in a container. The barrier 100 may be placed in a specific location in the container, predetermined to be that of, or approximately of, the dividing point between the plasma 11 and the solid blood components 12. When the blood is centrifuged, the blood may separate into plasma 11 and solid components 12. The solid blood components 12 may migrate to one end of the container through the barrier 100 and the plasma 11 may migrate to the other end. Because the barrier 100 has been placed at this dividing line, it therefore prevents the remixing of the blood components once the centrifugation has stopped.

In the above examples, the unseparated blood 10 is initially disposed on only one side of the barrier element 100. It will be understood, however, that this need not be the case. Because the barrier element is configured so that all blood components can pass through it, the unseparated blood can initially be on either side of the barrier 100 or on both sides of the barrier 100. In a scenario where centrifugation is initiated with unseparated blood on both sides of the barrier element 100, separation of components will occur on both sides of the barrier element. The continued application of a centripetal acceleration will cause plasma to flow in one direction through the barrier element and red blood cells to flow in the other direction through the barrier element. Ultimately, the two components will end up on opposite sides of the barrier just as in the previously described scenario.

Typically, barrier elements of the first type are formed so as to provide a porosity (i.e., ratios of void volume to overall volume) in a range of 70 to 92% so as to prevent passage of blood cells through the barrier element under 1 g conditions but allow passage of red blood cells under typical centrifugation conditions. The average fiber diameter used to produce these barrier elements are typically in a range of 5 to 20 microns.

The second type of bonded fiber barrier element involves structuring the element so that certain blood components can pass through the element, but other components cannot. With reference now to FIGS. 2A-2D, a bonded fiber barrier element 200 of the second type will be discussed in more detail. The bonded fiber barrier element 200 is configured to allow one or more blood components to pass through the bonded fiber element under predetermined conditions while preventing the passage of other components under the same conditions. In particular embodiments, the barrier element 200 may be configured to allow plasma 11 to pass through under conditions such as centrifugation, while preventing the passage of solid blood components 12. The bonded fiber element 200 has a first surface 201 and an opposing second surface 202 through which fluid may pass.

With reference to FIG. 2A, at time t₀ blood is introduced into a container on one side of the barrier element 200. Unlike the scenario described above for the first type of filter element, in this case, the blood must be introduced on the side of the barrier element that is opposite the direction of the acceleration that will result from centrifugation. At t₁, a centripetal acceleration a_{C} is established causing the blood to begin separating into its components, as illustrated in FIG. 2B. As discussed above, this also establishes a relative flow potential that causes the plasma 11 to move in the direction of the acceleration vector and the solid blood components 12 to move in the opposite direction. The barrier element 200 is configured so that the plasma component 11 is allowed to pass through the barrier 200. As will be discussed, the bonded fiber barrier element 200 may be formed and disposed in such a way so that it may move in response to a similar relative flow potential established by the centrifugation. This assures that the barrier element maintains fluid communication with the plasma 11 as it separates from the solid blood components 12.

With reference to FIG. 2C, at time t₂ the blood is completely separated and the barrier element 200 is disposed intermediate the plasma 11 and the solid blood components 12. At this time, the flow potential on the plasma 11 and solid components has returned to zero even though centrifugation has not stopped. At t_{F}, centrifugation is halted and the system returns to the initial conditions, as illustrated in FIG. 2D.

In some embodiments of the invention, the barrier 200 may be designed to move within a container holding the blood. In these embodiments, the barrier element 200 may be designed to have a specific gravity between that of the plasma 11 and the solid components 12. As a result, during centrifugation, the barrier 200 may assume a position between the plasma 11 and the solid components 12. Since the solid components 12 are not able to pass through the barrier 200, when centrifugation is ceased, the solid components 12 may be constrained by the barrier 200.

Typically, barrier elements of the second type are formed so as to provide a porosity in a range of 30 to 70% so as to freely allow passage of plasma under typical centrifugation conditions while preventing passage of red blood cells at all times. The average fiber diameter used to produce these barrier elements are typically in a range of 5 to 20 microns.

The barrier elements of the invention comprise porous, three dimensional, self-sustaining bonded fiber structures, which are formed from a plurality of thermoplastic fibers bonded to each other at spaced points of contact.

Many types of fibers have been used to make bonded fiber structures. However, a bonded fiber structure for use in blood separation applications requires a bonded fiber structure with particular characteristics. The bonded fiber structure must be constructed so as to have a density that provides pore sizes sufficiently small to block the passage of solid blood components through the structure under certain circumstances and, in some embodiments allow the passage of such components under other conditions. Further, the bonded fiber structure must be formed so that hemolysis of the red blood cells is prevented. Additionally, the fibers may be substantially hydrophobic and should exhibit good biocompatibility and thermal stability.

The fibers used to form barrier elements of the invention may be monocomponent or multicomponent fibers. As used herein, the term “multicomponent” refers to a fiber having two or more distinct components integrally formed from polymer materials having different characteristics and/or a different chemical nature. Bicomponent fibers are multicomponent fibers that have two distinct polymer components. It will be understood by those of ordinary skill in the art that the integrally formed polymer components of multicomponent fibers are distinguishable from coatings or material layers that may be adhered to a fiber after it has been extruded or spun. In particular embodiments of the invention, the fibrous network may comprise sheath-core multicomponent fibers.

The bonded fiber barrier elements of the invention may be formed using any of a variety of forming methods depending on the nature and form of the fibers being used and the desired properties of the final structure. The fiber material input to the forming process may be in the form of bundled individual filaments, tows, roving, webs or lightly bonded non-woven sheets. The fibers may be mechanically crimped or may be structured so that self-crimping may be induced (e.g., by stretching and then relaxing the fibers) during the continuous forming process. The fibers may also be melt blown or formed by a spun bond process. In particular, processes such as melt blowing allow production of finish-free fibers, which removes a source of potential contamination for fibers used in biological applications.

In particular embodiments, the fibers used to form filter elements according to embodiments of the invention may be provided in the form of:
Bundled individual multicomponent filaments, which may be crimped prior to forming to enhance entanglement and heterogeneity of the fiber network;
Bundled individual sheath/core bicomponent filaments, where the sheath/core arrangement is acentric (thereby making them self crimping), which may be stretched and/or relaxed to induce crimp prior to forming;
Tows of multicomponent fibers, which may be crimped prior to forming;
Tows of monocomponent fibers, which may be crimped and treated with plasticizer prior to forming.
Multicomponent staple fibers, processed into a roving or lightly bonded non-woven sheet;
Monocomponent staple fibers, treated with plasticizer and processed into a roving or lightly bonded non-woven sheet prior to forming;
Webs of melt spun or melt blown multicomponent fibers; and
Bimodal webs of melt blown fibers.

The above fiber materials may be formed into bonded fiber structures using any of several continuous bonding processes. A typical forming process for use with fiber materials comprising a bondable fiber component involves drawing the fiber materials through a heating zone to soften or melt the bondable material. The heating zone may include any of various mechanisms for heating the fiber material to a desired temperature, typically a temperature in excess of the melt or softening temperature of at least one fiber component, in order to facilitate bonding of the fibers at their points of contact with one another. The heating mechanism of the heating zone may include, for example, sources of radiant heat, hot air, or steam. The heating mechanism may include an oven or, in some embodiments, a heated die that not only serves as a heating mechanism, but also forces the fiber material to adopt a predetermined cross-section. Once the bonds have been established, the fiber material may be passed through a cooling zone to set the bonds established in the heating zone, thereby producing a self-sustaining bonded fiber structure.

The above techniques may be used to produce bonded fiber barrier elements of either of the previously described types. It will be understood that the bonded fiber barrier elements are preferably configured so that all blood components remain undamaged when centrifugation is applied. This is a particular concern with respect to the potential for hemolysis of the red blood cells that must contact and/or pass through the barrier elements.

The inventors have found that certain combinations of fiber materials and flow characteristics of the bonded fiber element provide the desired combination of separation performance with no hemolysis. One category of fibers that has demonstrated suitable performance is that of bicomponent sheath-core fibers with low density polyethylene (LDPE) sheath materials. Other sheath materials (non elastomeric) are polyolefins, such as polyethylene and polypropylene; polyesters including polyethylene terephthalate and polybutylene terephthalate; polymers of ethylene vinyl acetate, or ethylene methyl acrylate; polystyrene; as well as copolymers and derivatives of all of the foregoing. Such fibers may have a core formed from polypropylene, polybutylene terephthalate, polyethylene, polyethylene terephthalate, nylon 6 and nylon 6,6. In a particular embodiment, the fibers are sheath-core bicomponent fibers having an LDPE sheath and a polypropylene core. These fibers may be formed with sheath-core ratios in a range of 20:80 to 50:50 by volume. Sheath materials should generally be hydrophobic in nature, and should typically be compatible with biological systems.

The above fiber materials may be used in either type of barrier device. However, their use in devices of the second type may have drawbacks due to the configuration of typical blood separation containers. As has been previously described, when barrier elements of the type shown in FIGS. 2A-2D are used, the unseparated blood must initially be placed on the side of the barrier opposite the end of the tube toward which the acceleration vector is directed when the tube is under centrifugation. In most separation containers, however, this places the blood next to a closed or permanently sealed container wall. Thus, the only way to introduce blood into this portion of the container is through the barrier element.

As has already been discussed, a significant aspect of the second barrier type is that it is configured to prevent the passage of, for example, red blood cells through its interstitial passages. Thus, another means of transporting blood to this area is required.

A solution to this problem is provided through the use of elastomeric component multicomponent (ECM) fibers such as those described in co-pending U.S. patent application Ser. No. ______, filed Mar. 14, 2006 under Attorney Docket No. 61633.001139, which is incorporated herein by reference in its entirety. As described in that application, an ECM fiber is a multicomponent fiber having one or more elastomeric components that can be used to form resilient bonded fiber structures. As used herein, the term “multicomponent fiber” refers to a fiber having two or more distinct components formed from polymer materials having different characteristics and/or different chemical nature. Bicomponent fibers are a particular type of multicomponent fiber. As used herein, the term “bicomponent fiber” refers to a fiber having two or more distinct components integrally formed from polymer materials having different characteristics and/or different chemical nature. While other forms of bicomponent fiber are possible, the most common types are integrally formed with “side-by-side” or “sheath-core” relationships between the two polymer components. For example, bicomponent fibers comprising a core of one polymer and a coating or sheath of a different polymer are particularly desirable for many applications since the core material may be relatively inexpensive, providing the fiber with bulk and strength, while a relatively thin layer of a more expensive but unique sheath material may provide the fiber with unique properties, particularly with respect to bonding.

As used herein the term “elastomeric material” refers to a macromolecular material that returns rapidly to its initial dimensions and shape after substantial deformation and release of stress.

The properties of bonded fiber structures formed from ECM fibers provide advantages in a wide range of applications where elasticity or partial elasticity is required. A particular advantage in the present blood separation barrier application is that these structures tend to return to their original state after having been deformed. More particularly, these structures may regain their original configuration after penetration by fine, needle-like objects. This unique behavior results from the stretchable bonds formed by the elastomeric component of ECM fibers. It has been found that ECM-based structures having a base porosity may retain this porosity or experience only minor changes to this porosity when penetrated by needles with diameters far greater than the effective pore size of the passages through the structure. In exemplary embodiments, ECM-based bonded fiber barriers have been penetrated with needles having diameters in a range of 0.5 to 1 millimeter without significant degradation in separation performance. Larger and smaller diameter needles may also be possible, including needles with diameters from 0.0 millimeters up to or exceeding 2 millimeters.

The particular elastomeric material selected for use in blood separation barriers formed from ECM fibers may depend on a variety of factors including its spinning ability, bondability, the degree of resiliency required of the bonded fiber structure formed from the fiber, and other characteristics related to the use of the bonded fiber structure. A particular elastomeric material may be selected, for example, based on its relative hydrophobicity or based on its compatibility with fluids or other materials expected to interact with the bonded fiber structure. Additionally, fibers for use in blood separation barriers generally may not have any type of finish or coating applied that could affect the plasma sample.

The various elastomeric components of the ECM fibers of the invention may comprise any suitable elastomeric material. Suitable thermoplastic elastomers may include, but are not limited to: polyurethanes, polyester copolymers, styrene copolymers, olefin copolymers, or any combination of these materials. More particularly, thermoplastic polyurethanes, thermoplastic ureas, elastomeric or plastomeric polypropylenes, styrene-butadiene copolymers, polyisoprene, polyisobutylene, polychloroprene, butadiene-acrylonitrile, elastomeric block olefinic copolymers (such as styrene-isoprene-styrene), elastomeric block co-polyether polyamides, elastomeric block copolyesters, and elastomeric silicones may be used.

Of these elastomeric materials, thermoplastic polyurethanes have been shown to be particularly suitable for producing ECM fibers for use in bonded fiber structures. As used herein, the term “thermoplastic polyurethane” or “TPU” encompasses a linear segmented block polymer composed of soft and hard segments, wherein the hard segments are either aromatic or aliphatic and the soft segments are either linear polyethers or polyesters. The defining chemicals of TPUs are diisocyanates, which react with short chain diols to form a linear hard polymer block. Aromatic hard segment blocks are usually based in aromatic diisocyanates, most commonly MDI (4,4′-diphenylmethane diisocyanate). Aliphatic hard segment blocks are usually based in aliphatic diisocyanates, most commonly hydrogenated MDI (H12MDI). Linear polyethers soft segment blocks commonly used include poly(butylene oxide) diols, poly(ethylene oxide) diols and poly(propylene oxide) diols or products of reactions of different glycols. Linear polyester soft segment bocks commonly used include the polycondensation product of adipic acid and short carbon-chain glycols. Polycaprolactones may also be used. Thermoplastic polyurethanes are commercially available from suppliers such as DuPont®, Bayer®, Dow®, Noveon®, and BASF®.

Some ECM fibers used in barrier elements of the invention may have a fiber component (e.g., the core of a sheath-core ECM fiber) that comprises a crystalline or semi-crystalline polymer. Such polymers may include, but are not limited to: polypropylene, polybutylene terephthalate, polyethylene terephthalate, high density polyethylene and polyamides such as nylon 6 and nylon 66.

In some embodiments of the invention, the fiber barrier may loaded with or otherwise comprise heprin, ethylene diamine triacetic acid (EDTA), or other anti-coagulating agents.

As will be discussed in the examples below, particular embodiments of bonded ECB fiber barrier elements may be formed from sheath-core fibers having a TPU sheath and a polypropylene core. Other bonded ECB fiber barrier elements may be formed from sheath-core fibers having an elastomeric polypropylene sheath and a polypropylene core.

### EXAMPLES

1) Barrier Using Melt Blown PET/PBT Sheath-Core Fibers

In a first example of a bonded fiber structure for use as a barrier, the bonded fiber structure is formed from bicomponent sheath-core fibers with polyethylene terephthalate (PET) as the sheath material and polybutylene terephthalate (PBT) as the core material. When formed with a sufficiently small pore size, this structure has been shown to be successful in blocking passage of blood cells. Further, the melt blown PET/PBT fiber structure is inherently hydrophobic, biocompatible, and thermally stable.

Bicomponent sheath-core fibers were formed using Dupont® Crystar® PET 4449 and Ticona® Celanex® PBT 2000-3 as sheath and core materials, respectively, at a sheath/core ratio of 30:70 by volume. The PET was first dried at 125° C. for a minimum of 4 hours, and the PBT was dried for the same length of time at 120° C. The polymer materials were melted and extruded at a temperature range of 270 to 300° C. Hot air at 315° C. was used to draw and attenuate the fibers extruded from the melt blown spin beam. The resulting web was then quenched with cold air at a temperature of 10-15° C. At the collection table, a layer of fiber web with the desired fiber sizes (5-15 μm) was then collected and fed into a steam die. The temperature of the steam die was controlled at 95-105° C. under which the sheath materials melted and fused to each other forming a three dimensional, porous, self-sustaining rod, which was then cut to length. The resulting disk-like barrier structures had a diameter of 9.5 mm and a length of 3 mm with densities ranging between 0.18-0.42 g/cc, with porosities ranging from 70 to 87%.

2) Barrier Using Low Density Polyethylene (LDPE)/Polypropylene (PP) Sheath-Core Fibers

Self-sustaining, bonded fiber structures were also formed from melt blown sheath-core fibers. The fibers were formed using a Equistar® NA270 LDPE and an Atofina® PP3860 PP as sheath and core materials, respectively. The ratio of dried LDPE sheath material to PP core material was about 35:65 by volume. The LDPE sheath material and PP core material were extruded in a temperature range of 177° C. to 260° C. The resulting web displayed good bulk and softness. Steam bonding was used to form a self-sustaining structure, which was cut to the desired length. Fibers were produced with an average diameter of 14 microns. Bonded fiber structures were produced with densities in a range of 0.12 to 0.15 g/cc. These structures exhibited effective porosities in a range of 82% to 87%.

3) Barrier Using Melt Blown Thermoplastic Polyurethane (TPU)/Polypropylene (PP) Sheath-Core Fibers

Self-sustaining, bonded fiber structures were also formed from melt blown sheath-core ECM fibers. The ECM fibers were formed using a Noveon® Estane® X4280 TPU and an Atofina® PP3960 PP as sheath and core materials, respectively. The TPU was initially dried for 4 hours at 60° C. The ratio of dried TPU sheath material to PP core material was about 30:70 by volume. The TPU sheath material was extruded in a temperature range of 218° C. to 240° C., and the core resins were extruded in a temperature range of 177° C. to 199° C., with the fiber forming die tip at 168° C. The resulting web displayed good bulk and softness. Steam bonding was used to form a self-sustaining rod, which was cut to length. Bonded fiber structures were produced with a diameter of 7.5 mm and a length of 3 mm and densities in a range of 0.2 to 0.7 g/cc using fiber sizes in a range of 5 to 15 microns. These structures exhibited effective porosities in a range of 42% to 87% and exhibited the capability of returning to these porosity levels after penetration by and withdrawal of a 0.9 mm diameter needle.

4) Barrier Using Melt Blown Elastomeric Polypropylene (EPP)/Polypropylene (PP) Sheath-Core Fibers

Melt blown elastomeric bicomponent sheath/core fibers were formed using a using a ExxonMobil® Vistamaxx 2330 ethylene polypropylene copolymer elastomer (EPP) material and an Atofina PP3960 PP material, as the sheath and core materials, respectively. The ratio of the Vistamaxx sheath material to PP core material ranged from 30:70 to 50:50 by volume. The sheath and core resins were extruded at 177-260° C. Forming and bonding were accomplished using a combination of steam and air dies. Barrier structures were formed with densities in a range of 0.3-0.7 g/cc and fiber sizes in a range of 5-15 microns. Porosities ranged from 22 to 67%.

Testing

The example materials described above were subjected to the following testing procedures to determine their effectiveness as a barrier and, for ECM fiber structures, their ability to reseal after penetration:
1. 4-5 ml of swine (Pig) blood containing sodium citrate anticoagulation agent (Lampire biological Lab) were added into a collection tube.
2. The tube was then capped with a rubber stopper and placed in a centrifuge. The centrifuge spun the sample at 3500 rpm for 10 minutes.
3. The tube was then removed from the centrifuge and a non-pierced or a pierced barrier was inserted into the dividing line between plasma and the solid blood components. Pierced barriers were penetrated using a common blood needle with a diameter in a range of 720-920 microns and tested to determine resealing performance.
4. The tube was then recapped and placed upside down for each of 24, 48 and 100 hour periods to observe blood cell leakage.

The results of the above-described test were used to determine the relative separation performance of the barrier structures. Performance was compared before and after the structure had been penetrated by a standard needle in order to assess the relative resealing capability.

Table 1 illustrates performance results for barriers formed from polyethylene terephthalate (PET)-polybutylene terephthalate (PBT) sheath-core fibers. The results showed that the barrier structure was successful at maintaining separation when the average pore size was 4 microns, but unsuccessful at higher pore sizes. The PET/PBT structures with low pore sizes were generally unable to reseal (i.e., return to initial average pore size) after needle penetration but resealing was observed at higher pore sizes. There were no pore sizes where both blood cell blocking and resealing occurred.

TABLE 1
Effect of Pore Size on cell blocking and resealing ability on
PET/PBT filters

| Density | Average Pore | Cell Blocking | |
|---|---|---|---|
| (g/cc) | Size (μm) | Ability | Resealing Ability |
| 0.42 | 4 | Pass | Fail |
| 0.28 | 11 | Fail | Fail |
| 0.18 | 18 | Fail | Fail |
| 0.28 | 16 | Fail | Pass |
| 0.24 | 31 | Fail | Pass |
| 0.28 | 26 | Fail | Pass |
| 0.32 | 21 | Fail | Pass |

Barriers formed from elastomeric polypropylene (EPP)-polypropylene (PP) and TPU-PP bicomponent fibers were formed with average pore sizes of less than 4 microns and all were successful at maintaining separation of blood cell-rich and plasma-rich phases. The pore sizes for these structures were inferred based on the densities of the structures, because the elastomeric nature of the materials in the fibers makes standard porosimetry measurements inaccurate. Densities of 0.4 to over 0.6 g/cc were used for TPU-PP systems, and densities of 0.4 to 0.5 were used for EPP-PP. All produced acceptable barrier performance and all successfully resealed after needle penetration.

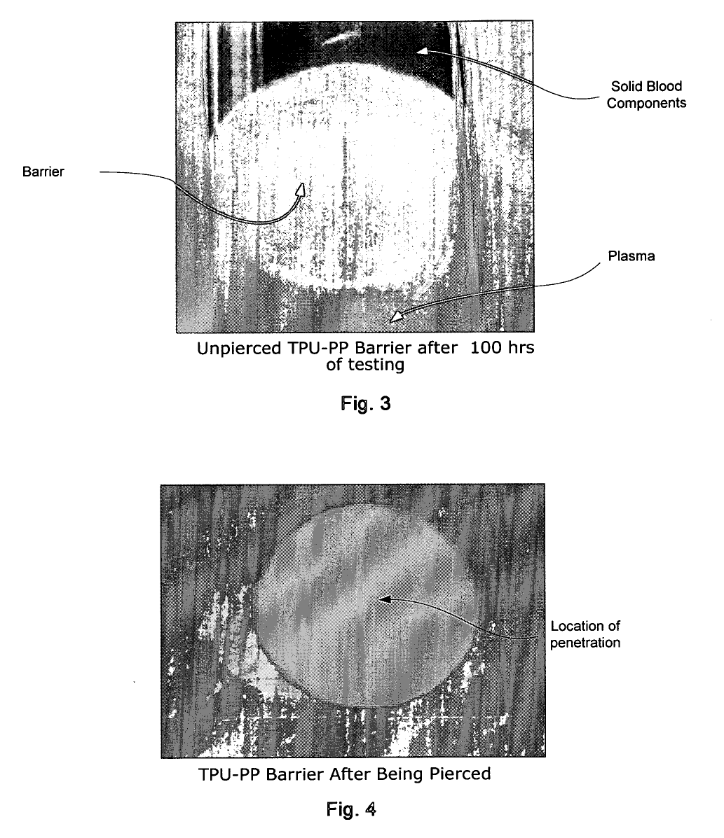

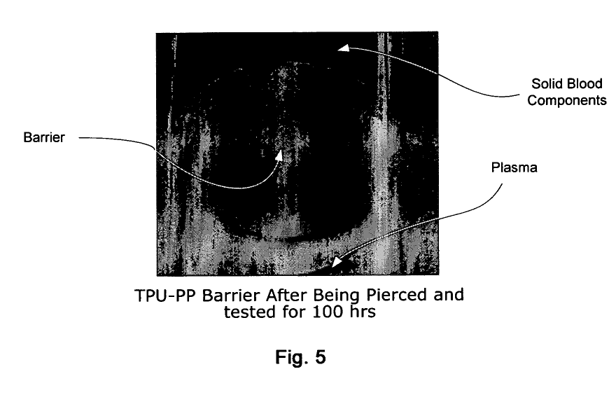

FIG. 3 illustrates the efficacy of an unpierced barrier formed from the TPU/PP ECM fibers after 100 hours of separating solid blood components from plasma. However, as discussed above, an advantage of barriers formed from ECM fibers is their ability to reseal after being pierced. FIG. 4 shows such a barrier formed from the TPU/PP ECM fibers after being pierced with a 0.92 millimeter diameter needle. FIG. 5 shows the same pierced barrier after 100 hours of separating solid blood components from plasma. It can be seen that the barrier effectively regained its ability to block passage of red blood cells and allowed no leakage after penetration and withdrawal of the needle.

It will be apparent to those skilled in the art that various modifications and variations can be made in the method, manufacture, configuration, and/or use of the present invention without departing from the scope or spirit of the invention.

What is claimed is:

1. A barrier element for use in separating blood components, the barrier element comprising:
a self-sustaining, fluid transmissive body comprising a plurality of thermoplastic fibers bonded to each other at spaced apart points of contact, the fibers collectively defining a tortuous fluid flow path through the fluid transmissive body from a first barrier surface to a second barrier surface, the fibers and the fluid transmissive body being configured to allow passage of at least one blood component therethrough while preventing the passage of at least one solid blood component.

2. A barrier element according to claim 1 wherein the fluid transmissive body maintains its capability of preventing passage of the at least one solid blood component after through-penetration of and withdrawal from the fluid transmissive body by a needle up to 2 mm in diameter.

3. A barrier element according to claim 1 wherein the thermoplastic fibers include multicomponent fibers having at least one component comprising an elastomeric polymer material.

4. A barrier element according to claim 1 wherein the thermoplastic fibers include sheath-core multicomponent fibers having an elastomeric polymer sheath material.

5. A barrier element according to claim 4, wherein the elastomeric polymer sheath material is a thermoplastic polyurethane.

6. A barrier element according to claim 4, wherein the elastomeric polymer sheath material is an elastomeric polyolefin.

7. A barrier element according to claim 1 wherein the thermoplastic fibers include sheath-core multicomponent fibers having a sheath material comprising polyethylene.

8. A barrier element according to claim 7 wherein the sheath-core multicomponent fibers have a core material comprising polypropylene.

9. A barrier element according to claim 1 wherein the at least one blood component includes blood plasma.

10. A barrier element according to claim 9 wherein the fluid transmissive body has a specific gravity intermediate a specific gravity of the blood plasma and a specific gravity of the red blood cells.

11. A barrier element for use in separating blood components, the barrier element comprising:
a self-sustaining, fluid transmissive body comprising a plurality of thermoplastic fibers bonded to each other at spaced apart points of contact, the fibers collectively defining a tortuous fluid flow path through the fluid transmissive body from a first barrier surface to a second barrier surface, the fibers and the fluid transmissive body being configured to allow passage of at least one solid blood component through the tortuous fluid flow path when a flow potential of at least a predetermined level is applied to the at least one solid blood component and to prevent passage of the at least one solid blood component in the absence of a flow potential of at least the predetermined level.

12. A barrier element according to claim 11 wherein at least a predetermined portion of the at least one solid blood component passed through the tortuous fluid flow path under the flow potential is undamaged.

13. A barrier element according to claim 11 wherein the flow potential is provided by centrifugal action.

14. A barrier element according to claim 11 wherein the thermoplastic fibers include multicomponent fibers having at least one component comprising an elastomeric polymer material.

15. A barrier element according to claim 11 wherein the thermoplastic fibers include sheath-core multicomponent fibers having an elastomeric polymer sheath material.

16. A barrier element according to claim 15, wherein the elastomeric polymer sheath material is a thermoplastic polyurethane.

17. A barrier element according to claim 15, wherein the elastomeric polymer sheath material is an elastomeric polyolefin.

18. A barrier element according to claim 11 wherein the thermoplastic fibers include sheath-core multicomponent fibers having a sheath material comprising polyethylene.

19. A barrier element according to claim 18 wherein the sheath-core multicomponent fibers have a core material comprising polypropylene.

20. A method of separating a solid blood component from plasma, the method comprising:
providing a self-sustaining, fluid transmissive body comprising a plurality of thermoplastic fibers bonded to each other at spaced apart points of contact, the fibers collectively defining a tortuous fluid flow path through the fluid transmissive body from a first barrier surface to a second barrier surface, the fibers and the fluid transmissive body being configured to allow passage of the solid blood component through the tortuous fluid flow path when a flow potential of at least a predetermined level is applied to the solid blood component and to prevent passage of the at least one solid blood component in the absence of a flow potential of at least the predetermined level;
placing the fluid transmissive body into fluid communication with a blood material comprising solid blood component and the plasma; and
applying a flow potential to the solid blood component sufficient to cause the solid blood component to separate from the plasma and pass through the tortuous flow path of the fluid transmissive body.

21. A method according to claim 20 wherein the thermoplastic fibers include multicomponent fibers having at least one component comprising an elastomeric polymer material.

22. A method according to claim 20 wherein the thermoplastic fibers include sheath-core multicomponent fibers having an elastomeric polymer sheath material.

23. A method according to claim 22, wherein the elastomeric polymer sheath material is a thermoplastic polyurethane.

24. A method according to claim 22, wherein the elastomeric polymer sheath material is an elastomeric polyolefin.

25. A method according to claim 20 wherein the thermoplastic fibers include sheath-core multicomponent fibers having a sheath material comprising polyethylene.

26. A method according to claim 25 wherein the sheath-core multicomponent fibers have a core material comprising polypropylene.

27. A method according to claim 20 wherein the flow potential is provided by centrifugal action.

28. A method of separating a solid blood component from plasma, the method comprising:
providing a self-sustaining, fluid transmissive body comprising a plurality of thermoplastic fibers bonded to each other at spaced apart points of contact, the fibers collectively defining a tortuous fluid flow path through the fluid transmissive body from a first barrier surface to a second barrier surface, the fibers and the fluid transmissive body being configured to allow passage of the plasma therethrough while preventing the passage of the solid blood component when a flow potential of at least a predetermined level is applied; and
applying a flow potential to the at least plasma and the solid blood component sufficient to cause the solid blood component to separate and to cause the plasma to pass through the tortuous flow path of the fluid transmissive body.

29. A method according to claim 28 wherein the thermoplastic fibers include multicomponent fibers having at least one component comprising an elastomeric polymer material.

30. A method according to claim 28 wherein the thermoplastic fibers include sheath-core multicomponent fibers having an elastomeric polymer sheath material.

31. A method according to claim 30, wherein the elastomeric polymer sheath material is a thermoplastic polyurethane.

32. A method according to claim 31, wherein the elastomeric polymer sheath material is an elastomeric polyolefin.

33. A method according to claim 28 wherein the thermoplastic fibers include sheath-core multicomponent fibers having a sheath material comprising polyethylene.

34. A method according to claim 33 wherein the sheath-core multicomponent fibers have a core material comprising polypropylene.

35. A method according to claim 28 wherein the flow potential is provided by centrifugal action.
